(19) United States
(12) Patent Application Publication
(10) Pub. No.: US 2015/0143494 A1
(43) Pub. Date: May 21, 2015

(54) CONTINUOUS IDENTITY AUTHENTICATION METHOD FOR COMPUTER USERS

(71) Applicant: National Taiwan University of Science and Technology, Taipei City (TW)

(72) Inventors: Yuh-Jye Lee, Taipei (TW); Chi-Tien Yeh, Taipei (TW); Chien-Yi Chiu, Taipei (TW)

(73) Assignee: National Taiwan University of Science and Technology, Taipei City (TW)

(21) Appl. No.: 14/289,343

(22) Filed: May 28, 2014

(30) Foreign Application Priority Data
Oct. 18, 2013 (TW) 102137593

(51) Int. Cl. G06F 21/31; G06F 21/45; H04L 29/06

(52) U.S. Cl. CPC G06F 21/316; H04L 63/08; G06F 21/45
USPC 726/7

(57) ABSTRACT

The present invention provides a continuous identity authentication method. This method transforms the behavior records of different time intervals of the system user into a text format, and uses a resampling technique to generate a large number of articles of different lengths in order to have behavior records of the system user in different lengths of time, then using a document classification technique to build a matrix. In the end, building behavioral models of different time periods of the system's user using Minimum Enclosing Ball technology. The behavioral models can then learn the behavior of the legitimate system user and continuously check whether the system is currently operated by the legitimate system user or not.

### PRIORITY CLAIM

This application claims the benefit of the filing date of Taiwan Patent Application No. 102137593, filed Oct. 18, 2013, entitled “A CONTINUOUS IDENTITY AUTHENTICATION METHOD FOR COMPUTER USERS,” and the contents of which is hereby incorporated by reference in its entirety.

### FIELD OF THE INVENTION

The present invention relates to a continuous identity authentication method, more particularly, to a method which could judge whether the usage behavior of the computer system is in an abnormal state or not, and then verifying whether the identity of the user of the computer system is legitimate or not.

### BACKGROUND OF THE INVENTION

In the past, most problems involved in information security included destroying the computer system of the user. For example, computer hackers mainly destroyed system files to make a computer system unusable. However, in the past few years, due to the progress of the Internet, valuable information and certifications are now gradually becoming digitized, such as credit card information or the internal secrets of a company. Because of this, hackers have now changed their priorities from destroying computer systems to stealing personal information and confidential data. Since information spreads on the Internet at very fast rates, many hackers have now begun gaining control of a user's account to compromise their account's contacts.

With the progress of cloud technology, many hackers have changed their target to information stored on cloud servers. Many systems have begun strengthening the security of their authentication system when logging in to prevent accounts from being hacked, for example, strengthening the security of passwords or applying complicated human verification mechanisms. These efforts can only strengthen the security of login mechanisms but cannot reduce the risk of a user's authentication information being hacked. Furthermore, these login verification mechanisms only verify the identity of the user's login credentials, which allows the system to still be vulnerable to other factors, for example forgetting to log out or being infected with a Trojan horse.

Therefore, the applicant proposes the present invention in order to protect users the moment they login to a computer to overcome the problems mentioned above.

### SUMMARY OF THE INVENTION

The present invention provides a continuous identity authentication method for computer users to solve the problems in the prior art. According to the statement mentioned above, the present invention proposes a continuous identity authentication method for computer users, which could protect the user immediately after logging into the system. The method creates a user's behavioral model for recognizing the behavior patterns of the user. When the system detects an unknown behavior pattern, it will apply corresponding steps immediately.

The major technical feature of the present invention is being able to continuously recording the usage behavior of a computer system with a client-side background program that does not interfere with controlling the system (the present invention uses a computer system as an example and the collected information comprises: a list of used applications by the user, a system resource usage, a processor utilization rate, a memory utilization rate, an access volume of the hard disk and an access volume of the network.). According to the collected user's behavior in controlling the computer system at different time intervals, a user's behavioral model is created. Using the user's behavioral model, the present invention will compare the current behavior's corresponding time interval to the behavior model. If the model determines the behavior as an abnormal event, the model executes a revalidation process. When the system judges the present behavior as abnormal, it will temporarily lock the computer system and send an email with an unlock link to the user's mailbox for the user to unlock the computer system or send a notification to a user's smart phone for the user to unlock the computer system using a mobile unlock application. Therefore the present invention can continuously predict the control behavior of a user in different time intervals and determine whether the control behavior corresponds to the user's established control behavior.

Many other advantages and features of the present invention will be further understood by the following detailed description and the appended drawings.

### BRIEF DESCRIPTION OF THE DRAWINGS

Some of the embodiments will be described in detail, with reference to the following figures, wherein like designations denote like members, wherein:

FIG. 1 is a block diagram of the continuous identity authentication method in an embodiment of the invention;

FIG. 2 is a main flow chart of the continuous identity authentication method in an embodiment of the invention;

FIG. 3 is a detailed flow chart of how the system operates the continuous identity authentication method mentioned in FIG. 2 in an embodiment of the invention;

FIG. 4 shows how the continuous identity authentication method converts the behavioral record into an article in an embodiment of the invention;

FIG. 5 is a flow chart of the technique used for taking samples in repetition of the continuous identity authentication method in an embodiment of the invention;

FIG. 6 is a flow chart of using classified document and the technique of taking samples in repetition to create a user's behavioral model of the continuous identity authentication method in an embodiment of the invention;

FIG. 7 is a flow chart predicting the behavior of the user of the continuous identity authentication method in an embodiment of the invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

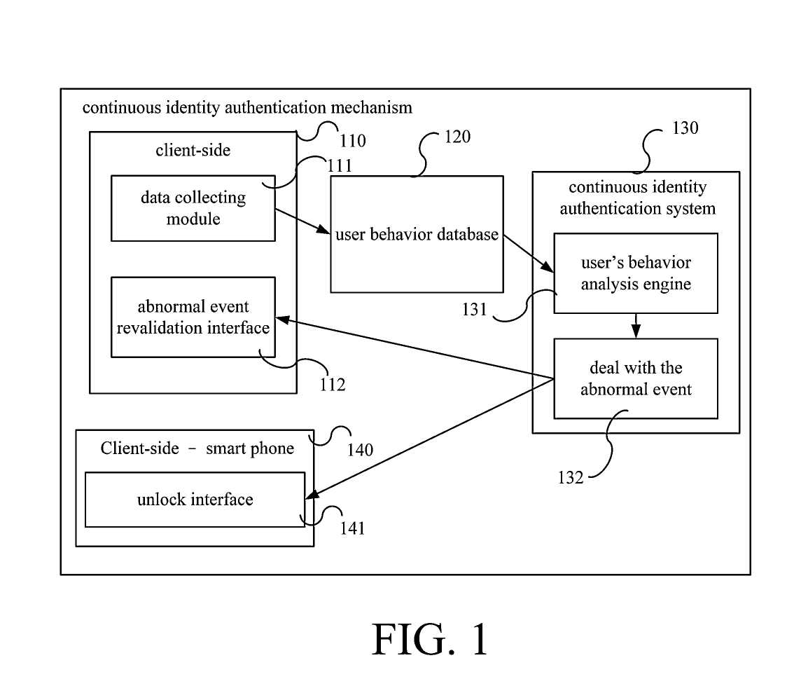

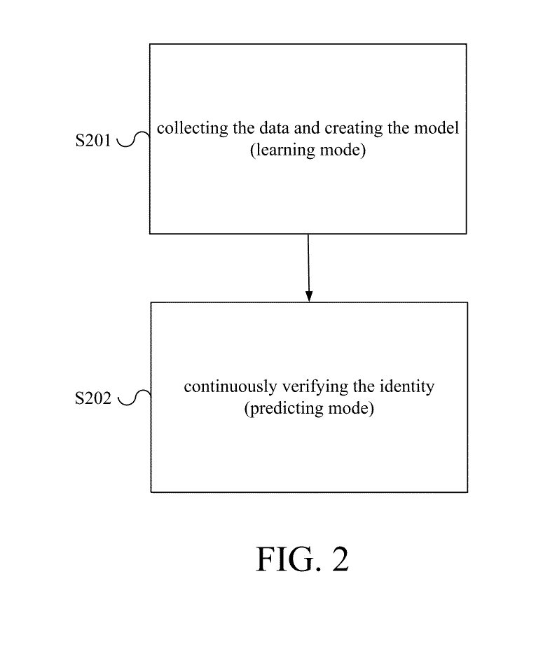

FIG. 1 is a block diagram of the continuous identity authentication method in an embodiment of the invention and FIG. 2 is the main flow chart of the continuous identity authentication method in an embodiment of the invention. According to FIG. 1, the continuous identity authentication method of the present invention is composed of a client-side background program 110, a user behavior database 120, a continuous identity authentication system 130 and a smart phone authentication interface 140. According to FIG. 2, the main flow path of the continuous identity authentication method of the present invention could be divided into two stages, which are stage S201 and stage S202. Stage S201 works to collect the data and create the behavioral model (learning mode), while stage S202 works to continuously verify the identity of the user (predicting mode).

As per FIG. 1, the client-side background program 110 comprises a data collecting module 111 and an abnormal event revalidation interface 112. The data collecting module 111 is used for collecting the usage behavior of the computer system, wherein the usage behavior comprises hardware resource usage information (such as processor information, memory information, access volume of the computer system's hard disk and an access volume of the computer system's network) and software usage behavior information (such as the name of software used by the user, the processor resource usage of the software, the memory usage of the software and the information of executing series). In addition, the data collecting module 111 will upload the behavioral data to the user behavior database 120, while the abnormal event revalidation interface 112 locks the computer system when an abnormal event is detected until the user unlocks it. The user behavior database 120 is a database system used to store the user's behavioral data collected by the client-side background program 110 for the continuous identity authentication system 130 to analyze. The continuous identity authentication system 130 comprises the user's behavior analysis engine 131 and deals with the abnormal event 132. The user's behavior analysis engine 131 converts the user's behavior into a group of articles with a first conversion program and then creates a user's behavioral model with a second conversion program. This part of the present invention will be illustrated in more detail later. In order to deal with the abnormal event 132, the behavior of the user at that moment is verified using the model created by the user's behavior analysis engine 131. If the similarity between the behavior of the user at that moment and the model created by the user's behavior analysis engine 131 is below a preset threshold, a notice is given to the client-side background program 110 and executes the abnormal event revalidation interface 112 which then sends an authentication link to the smart phone authentication interface 140. The smart phone authentication interface 140 is used for the user to unlock the computer system. After first installing an application program in a smart phone, the user will then have the ability to unlock the computer system through the unlock interface 141 of the application program. In another embodiment of the present invention, the user can to unlock the system through an email as another unlocking method. For example, the user could receive the email containing the unlock link. The revalidation process could be completed by the user clicking the unlock link contained in the email. It is worth noting that the revalidation process of the present invention is not limited to the application program of the smart phone or email. All the methods of unlocking the system remotely are comprised in the present invention.

According to FIG. 2, the main flow chart of the continuous identity authentication method 100 of the present invention is divided into two stages, stage S201 and stage S202. Stage S201 collects the behavior data and creates the behavioral model (learning mode). During this stage, the continuous identity authentication method 100 continuously collects the user's behavioral data and then adjusts the user's behavioral model until the model matches with the behavior of the user. When the model is satisfied with the condition mentioned above, it will enter stage S202, which is a stage of continuously verifying the identity (predicting mode). During this stage, the continuous identity authentication method 100 will continuously detect whether the behavior of the user at the moment is similar to the model in the corresponding time interval or not.

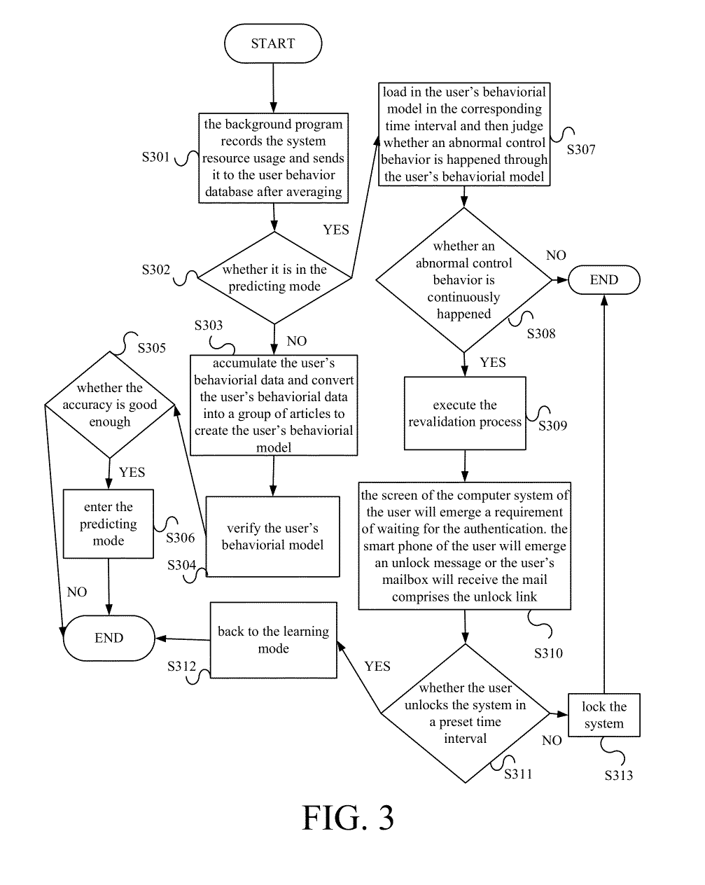

To make the flow chart of the present invention more clear, the following statements will explain the main flow chart mentioned above in detail. FIG. 3 illustrates a detailed flow chart of how the system operates in the continuous identity authentication method mentioned in FIG. 2 in an embodiment of the invention. This embodiment comprises the following steps of: step S301: the client-side background program recording the system resource usage every five seconds. After averaging the system resource usage every five seconds, the information being sent into the user behavior database 120. Step S302: reading the user's behavioral data from the user behavior database 120. If it is currently in the stage of continuously verifying the identity (predicting mode), enter step S307. If it is not in the stage of continuously verifying the identity (predicting mode), enter step S303. Step 303: when the user is at the stage of data collection and creation of the model (learning mode), the continuous identity authentication system 130 will constantly accumulate the user's behavioral data for a preset time and then convert the user's behavioral data into a group of articles with a first conversion program and a second conversion program to create the user's behavioral model. Step S304: verifying the user's behavioral model with cross validation technology. Step S305: judging the error rate and the accuracy rate of the user's behavioral model. If the error rate is low enough and the accuracy rate is high enough, enter step S306. If the error rate is not low enough and the accuracy rate is not high enough, going back to step S303 to recreate the model. Step S306: After confirming the user's behavioral model can accurately describe the control behavior of the user, changing to the stage of continuously verifying. Step S307: Immediately recording the user's behavior according to the time interval, then loading in the user's behavioral model corresponding to the time interval and then judging whether an abnormal control behavior has happened through comparison with the user's behavioral model. Step S308: judging whether an abnormal control behavior is continuously happening. If the abnormal control behavior is continuously happening, enter step S309. If the abnormal control behavior is not continuously happening, stay in step S308 to continue detecting. Step S309: if the control behavior at the moment is detected as an abnormal control behavior, execute the revalidation process. The client-side background program will lock the computer system temporarily and send an email with an unlock link to a user's mailbox or a notification to an application installed on the user's smart phone to allow the user to unlock the computer system. Step S310: the screen of the computer system will emerge a requirement waiting for the authentication link and will be unusable. All actions on the computer system will be stopped and the user's smart phone will receive an unlock message or the user's mailbox will receive an e-mail containing the unlock link. Step S311: judge whether the user has unlocked the system in a preset time interval. If the user unlocks the system in a preset time interval, enter step S312. If not, enter step S313. Step S312: if the user unlocks the system, the system will go back to the stage of collecting data and creating the model as the previous lockout is deemed as a misjudgment of the user's behavioral model. Step S313: the link between the computer system and the user will be cut off and the account will be locked temporarily to insure the safety of the computer system. It is worth nothing that the time interval that the client-side background program collects the system resource usage during step S301 is not limited to five minutes. It could be adjusted according to different conditions.

More specifically, the first conversion program mentioned in step S303 loads the user's behavioral data from the user behavior database 120 in every preset time interval and interprets each user's behavioral data as words to generate a segment of words, and then randomly disassembling and repeatedly combining the segment of words so as to form articles with different length for further generating the group of articles. The second conversion program constantly converts the group of articles into vectors to generate a first matrix, then reducing the order of the first matrix through a reduce order method to generate a second matrix, and finally creating the user's behavioral model from the second matrix by using a minimum enclosing ball method.

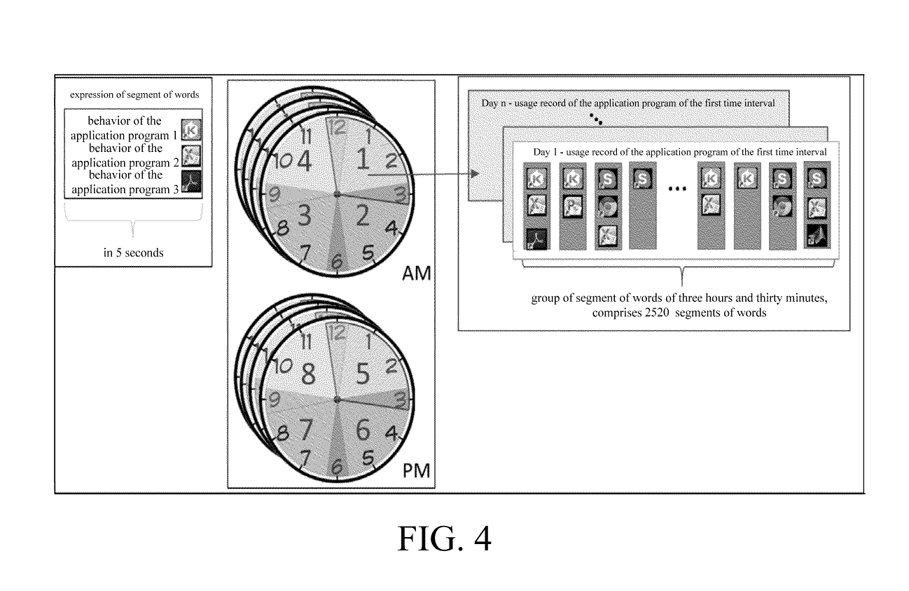

Furthermore, in an embodiment of the present invention, to more specifically describe the control behavior of the user, the user's behavioral model in different time intervals is created by the user's behavioral data in different time intervals. FIG. 4 illustrates how the continuous identity authentication method converts the behavior record into articles in an embodiment of the invention. As shown in FIG. 4, a day is divided into eight parts, with each part comprising three hours. The eight parts creates eight behavior patterns of the user in a day. To smooth out the differences in each part, each part further comprises fifteen minutes before the part and fifteen minutes after the part, so that there are three hours and thirty minutes in each part. In this embodiment, the record of the application programs used in the system are stored every five seconds and then combined into a segment of words. Therefore, each part of the time in a day will generate 2520 segments of words. These 2520 segments of words will generate a group of articles in different time intervals through the first conversion program and then create the user's behavioral model in different time intervals through the second conversion program. Therefore, the user's behavioral model can accurately describe the control behavior the user on the computer system in different time intervals. More specifically, each different time interval of the user's behavioral model is created individually.

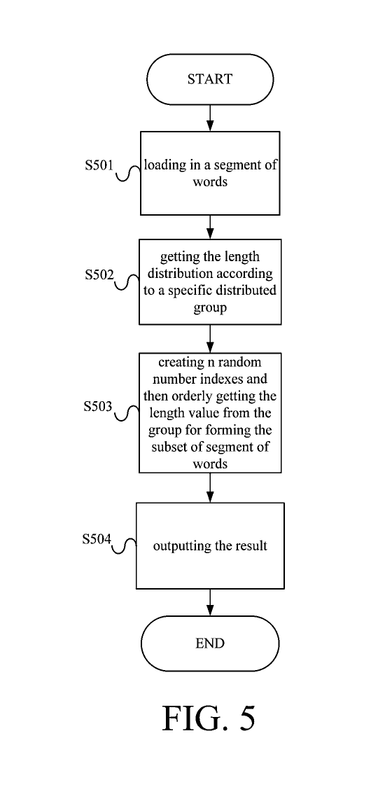

Furthermore, the randomly disassembling and repeatedly combining the segment of words to form the articles with different length to further generate the group of articles mentioned in the first conversion program will be explained by an example in this paragraph. FIG. 5 illustrates a flow chart of the technique, which takes samples in repetition of the continuous identity authentication method in an embodiment of the invention. This embodiment comprises the following steps of: step S501: loading a segment of words of certain time intervals in a day. Step S502: creating a specific distributed group P comprising n random numbers, wherein the n represents the amount of sampling with the created random number being between zero and one, and the random number of times the maximum sampling length k to get the length distribution. Step S503: creating n random number indexes, wherein the range of the random number indexes is between 0 and 2519. Orderly getting the length value from the group of random number P. Obtaining the segment of words which the range of index is between ni and ni+Pi to form the subset of segment of words, which is an article. Step S504: outputting the group of articles of the time interval. This flow path is an embodiment of the method of repeatedly obtaining samples for forming the group of articles in the present invention. All collected user's behavioral data in the different time intervals have to follow this flow path to generate the group of articles in the specific time interval. Then through the second conversion program, the user's behavioral model of that specific time interval will be created. Furthermore, when in stage S202 of continuously verifying the identity (predicting mode) of FIG. 2, it still has to follow the flow path mentioned above to form the group of articles using the user's behavioral data, which then allows the step of comparing to the user's behavioral model and the other steps to be continued. It is worth nothing that the method of repeatedly obtaining the sample is not limited to the method mentioned in this embodiment. As long as the method can randomly disassemble and repeatedly combine the segment of words, it is comprised in the present invention.

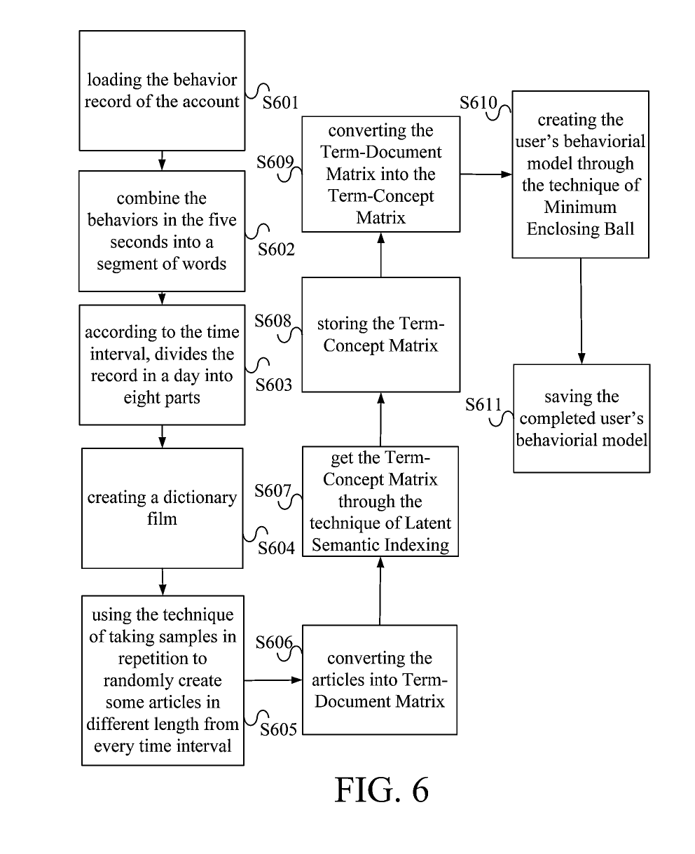

FIG. 6 illustrates a flow chart using a classified document and the technique of taking samples in repetition to create a user's behavioral model for the continuous identity authentication method in an embodiment of the invention. This embodiment comprises the following steps of: step S601 to step S603: which were previously explained in FIG. 4. Step S604: creating a dictionary film to save the words generated by the user's behavioral data for each time interval for the following steps to use. Step S605: which was previously explained in FIG. 5. Step S606: observing every article in the group of articles as vectors and then expressing them as matrixes. Every factor of the matrix is an indicated value converted by the words from the dictionary film. The indicated value is decided upon according to the importance of the word in the article wherein the importance is decided upon according to the amount the word is presented in an article and the amount of articles which contain the word. This can obtain the first matrix (Term-Document Matrix) of the eight time interval through the articles of each time interval having been converted into matrices. Steps S607 S608: To reduce the dimension, the present invention reduces the order of the first matrix through the Latent Semantic Indexing technique and then obtains the second matrix (Term-Concept Matrix) of the eight time intervals. After the second matrix is obtained, the data operation will operate by being converted into the matrix. Step S609: converting the first matrix (Term-Document Matrix) into the second matrix (Term-Concept Matrix) to create the model. Step S610: creating the user's behavioral model through the Minimum Enclosing Ball technique. Step S611: saving the completed user's behavioral model.

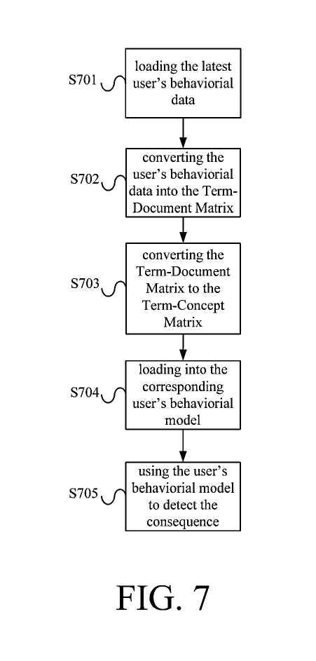

This next paragraph will show the flow path of how to verify the legitimacy of the user by comparing whether the user of the computer system is similar or not to the user's behavioral model after entering stage S202 of continuously verifying the identity (predicting mode) in FIG. 2. FIG. 7 illustrates a flow chart of predicting the behavior of the user of the continuous identity authentication method in an embodiment of the invention. This embodiment comprises the following steps of: step S701: loading the user's latest behavioral data from the user behavior database 120 and observing it as an article. Step S702: converting the user's behavioral data loaded in step S701 to the first matrix (Term-Document Matrix) through step S606 mentioned in FIG. 6. Step S703: converting the first matrix (Term-Document Matrix) to the second matrix (Term-Concept Matrix). Step S704: loading in the corresponding user's behavioral model according to the time interval of the loaded user's behavioral data. Step S705: using the user's behavioral model to detect if the result generated in step S703 is abnormal. In brief, the user's behavioral model is of a matrix format. The user's behavioral data recorded by the background program is compared with the user's behavioral model. The user's behavioral data recorded by the background program can also be converted into the matrix format by the first conversion program and the second conversion program, and then the converted user's behavioral data is compared with the user's behavioral model. If the similarity between the user's behavioral data and the user's behavioral model is below a preset threshold after the comparison, the situation is determined to be an abnormal event and the computer system will then be temporarily locked and execute revalidation process will be executed.

To conclude the statements mentioned above, the present invention of a continuous identity authentication method for computer users is a method which can continuously identify whether the user of the computer system is legitimate or not. Its core technology lies in converting the user's behavior of different time intervals into an article format and using the technique of document classification to create the first matrix (Term-Document Matrix). Through the method of repeatedly obtaining samples, it can generate many articles of different lengths to get the user's behavioral data in different time lengths. Lastly, the user's behavioral model of different time intervals is created by the Minimum Enclosing Ball technique to immediately detect and judge whether the control behavior of the computer system in different time intervals is legitimate or not.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A continuous identity authentication method for computer users, used for verifying the identity of a user of a computer system, comprising the following steps of:
continuously recording the usage behavior of the computer system and generating a user's behavioral data with a background program after the user is logged into the computer system;
storing the user's behavioral data in a user behavior database;
converting the user's behavioral data of a preset learning time into a group of articles with a first conversion program;
creating a user's behavioral model from the group of articles with a second conversion program;
comparing the user's behavioral data recorded by the background program with the user's behavioral model at a preset time interval after the user's behavioral model is created;
if the similarity between the user's behavioral data and the user's behavioral model is below a preset threshold, the situation is determined to be an abnormal event; and
temporarily locking the computer system and executing a revalidation process when an abnormal event occurs.

2. The continuous identity authentication method for computer users of claim 1, wherein the first conversion program is constantly reading the user's behavioral data from the user behavior database at a preset time interval, interpreting each user's behavioral data as words for generating a segment of words, then randomly disassembling and repeatedly combining the segment of words so as to form articles with different lengths for further generating the group of articles.

3. The continuous identity authentication method for computer users of claim 1, wherein the second conversion program is constantly converting the group of articles into vectors for generating a first matrix, then reducing the order of the first matrix by a reduce order method for generating a second matrix, finally creating the user's behavioral model from the second matrix using a minimum enclosing ball method.

4. The continuous identity authentication method for computer users of claim 1, wherein the user's behavioral model is of matrix format, when comparing the user's behavioral data with the user's behavioral model, the user's behavioral data recorded by the background program can also be converted into the matrix format by the first conversion program and the second conversion program, and the converted user's behavioral data is then compared with the user's behavioral model.

5. The continuous identity authentication method for computer users of claim 1, wherein the user's behavioral data comprises hardware resource usage information and software usage behavior information.

6. The continuous identity authentication method for computer users of claim 5, wherein the hardware resource usage information comprises a processor utilization rate, a memory utilization rate, an access volume of the hard disk and an access volume of the network.

7. The continuous identity authentication method for computer users of claim 5, wherein the software usage behavior information comprises a list of used application programs by the user and a system resource usage thereof

8. The continuous identity authentication method for computer users of claim 1, wherein the revalidation process comprises sending an email with an unlock link to a user's mailbox for the user to unlock the computer system.

9. The continuous identity authentication method for computer users of claim 1, wherein the revalidation process comprises sending a notification to a user's smartphone so that the user can use a mobile unlock application to unlock the computer system.

10. The continuous identity authentication method for computer users of claim 1, wherein if the user uses the revalidation process to unlock the computer system, it means that a misjudgment was generated from the user's behavioral model, the background program will then record the misjudgment in the user behavior database so as to update the user's behavioral model.
